(19) United States
(12) Patent Application Publication
(10) Pub. No.: US 2006/0082544 A1
(43) Pub. Date: Apr. 20, 2006

(54) Dynamic single row QWERTY key layout

(75) Inventors: Christopher P. Wieck, San Diego, CA (US); Graham Clift, Poway, CA (US)

Correspondence Address: ROGITZ & ASSOCIATES, 750 B STREET, SUITE 3120, SAN DIEGO, CA, 92101, US

(73) Assignees: Sony Corporation; Sony Electronics Inc.

(21) Appl. No.: 10/967,861

(22) Filed: Oct. 18, 2004

(51) Int. Cl. G09G 5/00

(52) U.S. Cl. 345/156

(57) ABSTRACT

A computer keyboard is provided that has one and only one row of keys for inputting letters. The keys of the row can each represent one of at least three letters. Thus, the row can instantiate the top row of letters in a conventional QWERTY layout, or the middle row, or the bottom row, or even the number row depending on what the user selects, thereby consuming less space than a conventional multi-row QWERTY keyboard and also thereby presenting enhanced ergonomics relative to a conventional QWERTY layout.

### FIELD OF THE INVENTION

The present invention relates generally to data input devices and more particularly to user-manipulable data entry keyboard devices and the like.

### BACKGROUND OF THE INVENTION

Most keyboards, key pads, and the like (collectively referred to herein generically as “keyboards”, including devices that have touch screen buttons and devices that have movable keys and regardless of the particular application) are laid out in the well-known QWERTY arrangement, so named for the first several letters in the top row of letters. A conventional QWERTY keyboard has three rows of letters, one row of numbers, and several special purpose keys, including space bar, back space, etc. Also, most computer QWERTY keyboards have a row of function keys.

As recognized herein, owing to the minimum of four rows of keys, the QWERTY layout requires considerable space, both across the keyboard to accommodate the lengths of the rows and from top to bottom on the keyboard to accommodate the number of rows. As also recognized herein, this space requirement can pose design challenges for smaller devices such as notebook PCs and smaller.

Accordingly, many small devices have been provided that have very small buttons. Unfortunately, many users experience difficulty typing on small buttons. Further, the present invention understands that the ergonomics of a QWERTY key arrangement are less than desirable.

Having made the above critical observations, the invention herein is provided.

### SUMMARY OF THE INVENTION

Embodiments of the present invention address the issues noted above, namely, size and ergonomics by providing only a single row of user-manipulable keys that consumes only one fourth of the space consumed by a conventional four-row QWERTY keyboard with like-sized keys. Because only a single row is provided, the contour of the row can be designed very ergonomically because whether typing by fingers or thumbs, the natural reach is along a line, albeit curved. Which QWERTY-layout row is instantiated by the single row of keys is selectable, in that the user can select, by means of a selector element, whether the keys represent the number row of a conventional QWERTY keyboard, the top letter row of a conventional QWERTY keyboard, the middle letter row of a conventional QWERTY keyboard, or the lower letter row of a conventional QWERTY keyboard.

Accordingly, in one aspect a data input device includes one and only one row of user-manipulable letter keys. The letter keys are the only means on the device to input letter characters. A selector element is provided that can be manipulated by a user to selectively cause the row of user-manipulable letter keys to instantiate a top row of keys in a QWERTY layout, or a middle row of keys in a QWERTY layout, or a bottom row of keys in a QWERTY layout.

In non-limiting implementations the selector element may include one or more buttons, or one or more spring-loaded flip switches, or one or more jog rollers. If desired, the keys can be arranged in an ergonomic arcuate pattern. Non-alphanumeric special function keys can also be provided.

In another aspect, a data input device includes plural letter keys arranged in a single row. At least some letter keys represent a user-selected one of at least three letters, such that which letter is represented by a letter key is selected by a user.

In still another aspect, a data entry device includes plural letter keys, at least some of which are correlatable to one of at least three letters. Means are provided for allowing a user to correlate at least one letter key to one of plural letters.

In another aspect, a logic device includes means for receiving a user row selection signal, and means for correlating a row of user manipulable keys to one of at least three QWERTY-arranged key rows in response to the row selection signal.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present input device system;

FIG. 2 is an elevational view of one keyboard display showing the selected row highlighted;

FIG. 3 is an elevational view of one keyboard display showing the selected row highlighted with the shift key also selected; and

FIG. 4 is a perspective view, front and back, of an exemplary non-limiting embodiment of the input device in one intended embodiment.

### DETAILED DESCRIPTION OF THE PREFERRED EMBODIMENT

As used herein, the term “key” includes elements that are activated by a user's touch to generate a signal representative of a character such as a letter, number, punctuation mark, and the like, including keyboard keys or buttons, key pad keys, touch screen keys, and projection keys.

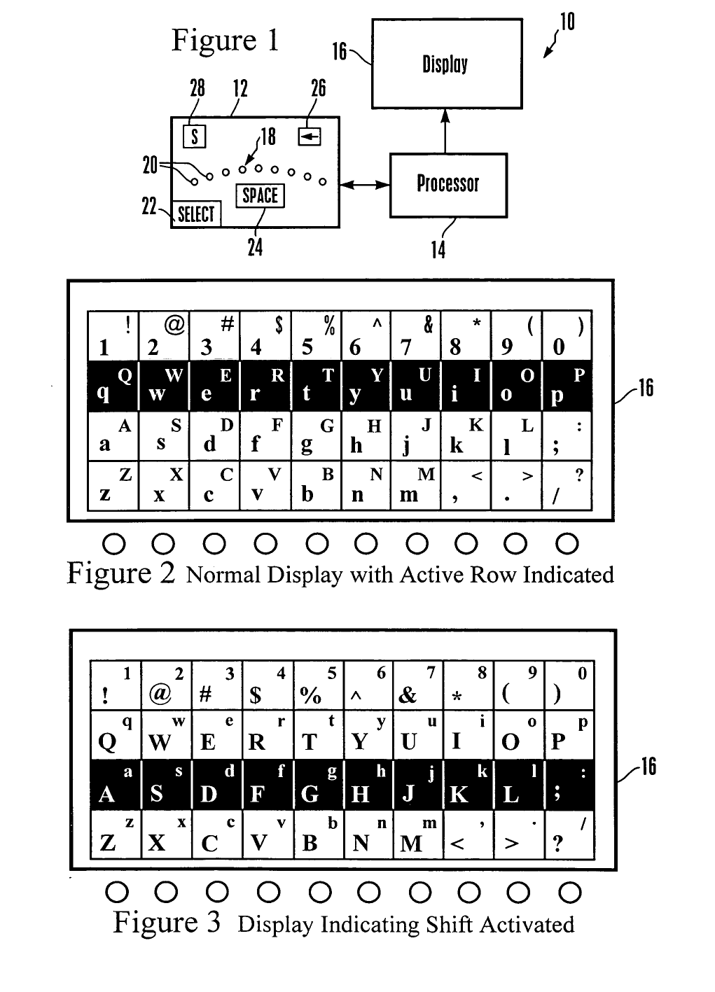

Referring initially to FIG. 1, a system is shown, generally designated 10, that includes an input device 12 according to the present invention for inputting signals to a logic device such as but not limited to a processor 14. The processor 14 in turn controls an output device such as a display 16. The system 10 may be implemented in a laptop computer, hand held computer, wireless telephone, or other computing device.

As shown, the input device 12 has one and only one row 18 of letter keys 20, each of which may be manipulated by a user to generate a signal representative of a keyboard character for use of the signal by the processor 14. In non-limiting embodiments the row of keys 20 is ergonomically arcuate, such that the reach of the typing fingers and/or thumb is near constant to allow the user to use the minimal amount of action to direct the typing action without having to significantly bend the fingers and/or thumbs.

The keys 20 are letter keys, in that the signals from these keys represent letters and may represent numbers and punctuation symbols as set forth more fully below. In the embodiment shown ten letter keys 20 are provided, it being understood that greater or fewer keys can be provided. In any case, in the embodiment of FIG. 1 the row 18 of letter keys 20 is the only means on the device 12 to input letter characters.

As further shown in FIG. 1, the device 12 also includes a selector element 22. The selector element 22 may be established by one or more buttons, and/or one or more spring-loaded flip switches, and/or one or more jog rollers, in accordance with principles discussed below. In any case, the selector element 22 is manipulable by a user to selectively cause the row 18 of letter keys 20 to instantiate a top row of keys in a QWERTY layout, or a middle row of keys in a QWERTY layout, or a bottom row of keys in a QWERTY layout. Consequently, when the row 18 instantiates the top row, the keys represent, in order from left to right, the letters “q”, “w”, “e”, “r”, “t”, “y”, “u”, “i”, “o”, and “p”. On the other hand, when the row 18 instantiates the middle row, the keys represent, in order from left to right, the letters “a”, “s”, “d”, “f”, “g”, “h”, “j”, “k”, “l”, and the semicolon character (when no shift has been indicated; otherwise the colon character is indicated), as dictated by a QWERTY layout. When the row 18 instantiates the bottom row, the keys represent, in order from left to right, the letters “z”, “x”, “c”, “v”, “b”, “n”, “m”, and, when no shift has been indicated, the comma character, the period character, and the back slash character, it being understood that the right-most three keys 20 can indicate, when a shift has been indicated, the left bracket, right bracket, and question mark characters, respectively, as dictated by a QWERTY layout. In any case, as to the letters, the single row 18 of keys 20 instantiates one of three rows in a conventional QWERTY keyboard arrangement.

If desired, the selector element 22 can also be manipulated to cause the row 18 to instantiate a row of number keys, i.e., the top-most row of keys on a conventional QWERTY keyboard. When a shift is indicated and the “number” row selected, the keys can represent, from left to right, the characters for exclamation point, the @ sign, the pound sign, the dollar sign, the percentage symbol, the carat symbol, the ampersand symbol, the asterisk, the open parenthesis, and the closed parenthesis. Still further, some computer-related QWERTY keyboards have a row of function keys above the number key row, and the user can select this row for implementation by the row 18 using the selector element 22.

Additionally, one or more non-alphanumeric special function keys can be provided on the device 12. For instance, a “space” bar or key 24 can be provided, as can a backspace key 26 and a shift key 28, which generate the conventional signals generated by such keys in accordance with keyboard principles known in the art. Other special functions keys such as “capitals lock” may be provided.

More broadly, in accordance with the disclosure above each of the seven left-most letter keys 20 can represent a user-selected one of at least three letters, such that which letter is represented by a letter key is selected by a user. Thus, with respect to all ten letter keys 20, at least some letter keys are correlatable to one of at least three letters. In any case, in the preferred implementation shown in FIG. 1, the keys 20 are defined as a group, not individually, i.e., the selects which one of four (or, when a function key row is to be made accessible, which one of five) predefined QWERTY-arranged rows is to be instantiated by the single row 18.

Because the character represented by each key 20 changes depending on which row the user selects to be instantiated, it may be desirable to present an indication to the user of what character is being represented by each key 20, although in some implementations (e.g., for trained touch typists) no indication need be provided. In one embodiment, which may be particularly although not exclusively useful for keys that are implemented in a touch screen, the character represented by the key can be displayed on the key itself.

FIGS. 2 and 3, however, show another implementation wherein the characters represented by the keys are not displayed on the keys 20 but rather are presented on the display 16 shown in FIG. 1, or on an adjacent display if desired. As shown in FIGS. 2 and 3, all four rows (numbers row plus three letters rows) of a conventional QWERTY keyboard can be displayed, with the row currently instantiated being highlighted. FIG. 2 shows the display without “capitals lock” or “shift” selected, while FIG. 3 shows the display if “capitals lock” and/or “shift” is selected. Note that each representation of a key shown in FIGS. 2 and 3 can display, in superscript format, the non-selected form of the character, i.e., if small case is selected the capitalized form of the letter is displayed in superscript and vice-versa. In some implementations, displaying the single instantiated row might be sufficient, and if desired the user can be provided with a means (e.g., a button) to selectively turn off the keyboard display altogether.

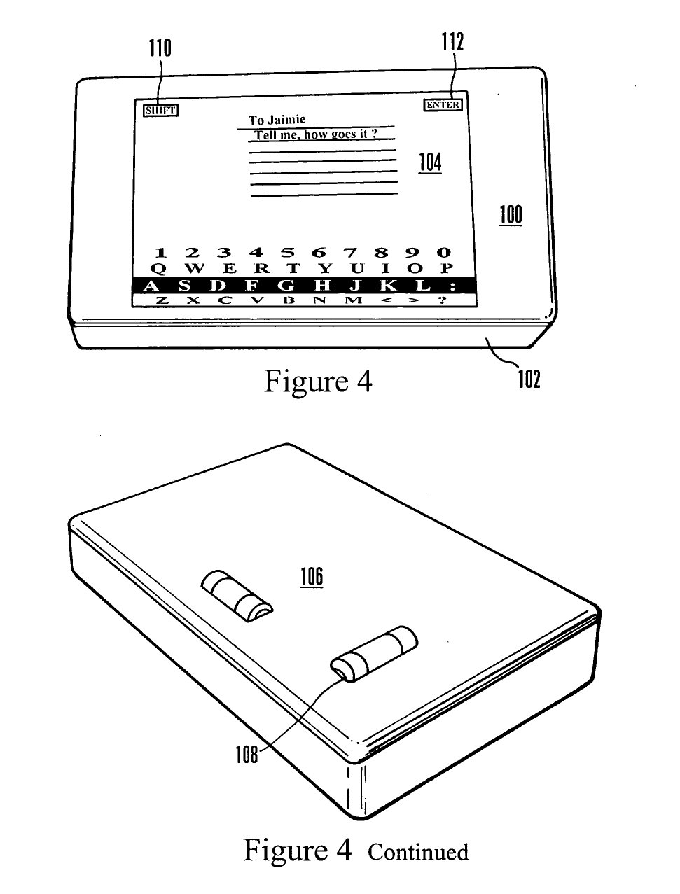

In yet another implementation of the keyboard display, FIG. 4 shows a computing device 100 that has a single row of letter keys 102 in accordance with principles set forth above and a display 104. The display 104 can display the rows of a QWERTY keyboard as though arranged in parallel lines longitudinally on an imaginary cylinder as shown, with the row facing towards the user representing the instantiated row. This also brings the instantiated row closer to the keys 102, allowing for easier alignment by the user's sight.

The skilled artisan will appreciate that the device 100 can have a processor and can be implemented as a small hand held computing device, with the typing intended to be done using the thumbs. On the back 106 of the device (i.e., on the surface opposite the display 104), two orthogonally-oriented rotatable flip switches 108 may be mounted to establish a selector element, while on the other side the display 104 may include “shift” and “enter” buttons 110, 112. In this particular implementation the index fingers of each hand control the shift and enter buttons 110, 112 and the middle or ring fingers of each hand, which wrap around the device 100 to support it, can operate the flip switches 108. The orientation of the flip switches 108 naturally designate their function: the switch 108 that naturally rolls in the up and down direction relative to the display 104 can be assigned for row selection and the switch 108 that naturally rolls in the left and right direction relative to the display 104 can be assigned for space/backspace. For non-word processing functions, the switches 108 can serve as navigation keys.

In all embodiments, a default instantiated row can be defined. The default row can be, e.g., the “ASDFGHJKL” home row. In a two button actuation scheme, pressing one button can cause the “ZXCVBNM” row to be instantiated, and pressing another button can cause the “QWERTY” row to be instantiated. Pressing both could instantiate the number row. If the device has a phone dialing mode, the default row could be the numbers row for ease of dialing.

In any case, the signals from the selector element can be received by the processor (e.g., by the processor 14 shown in FIG. 1) or by another logic device such as but not limited to an application specific integrated circuit (ASIC) and used to determine which keyboard row should be instantiated by the letter keys. The logic device thus correlates a row of user manipulable keys to one of at least three QWERTY-arranged key rows in response to the row selection signal generated when a user manipulates (including releasing, to return to home/default) the selector element.

As mentioned above, the selector element can be established by one or more jog rollers. Yet again, as shown in FIG. 4 the selector element can be one or more spring-loaded flip switches that can be moved to instantiate a row other than the default row and that can return to a home position and, hence, the default row when released by the user, such that any character effectively is within a single flip's reach.

In non-limiting exemplary embodiments, if the user needs to type consecutive letters on a non-home position row, the user can simply hold the flip switch in the appropriate position. It can be desirable that in the space between a double click of the flip switch, the instantiated row would first return to the default row, and if no character is typed in this action, the instantiated row could be changed to the number row.

Yet again, a flip switch can be oriented at 45 E to the display such that up/down row transitions are at a 45 E degree position, and a further −70 E position for the digits, so that the row could be distinguished by the hardware alone.

Still further, if desired the position of the flip switch when a row such as the number row is instantiated could be sticky, so that it would not return to home (default) position upon release, to allow for easily typing many consecutive digits. Such a feature could be useful for address/phone book entries. The additional flip distance can mirror the extra distance to reach numbers on a standard keyboard.

A “sticky” flip switch position can also be provided in the opposite direction to enable special function keys for another purpose, e.g., for “hot keys” that navigate the main device functions before punching down into a text entry mode. This position could be used to get to a top level menu at any time. As an alternative, a standard three-position flip switch can be provided that does not return to the default position upon release, but must be affirmatively moved there by a user. Furthermore, whether the flip switch returns to the default position (row) upon release can be selected by the user in software, allowing an unlimited number of rows to be represented without the user having to hold the flip switch in any fixed position when accessing any particular row. Still again, another alternative when a three-position flip switch is used is to provide another button in conjunction with the flip switch to actuate the number row.

The space/backspace button shown above, since it represents a directional function, can be replaced by a flip switch that is controlled by a simple flick of the finger, or held for continuous backspace. Holding for continuous spacing can have a short time-out to switch to a TAB function, but with a delay between consecutive tabulations, to save button space and release the other fingers for ease of use. If desired, the simultaneous use of such a tab/backspace flip switch in conjunction with manipulating the row selection flip switch can represent an indication to continue past the QWERTY row (i.e., to the number row) in the return-to-home typing embodiments.

While the particular DYNAMIC SINGLE ROW QWERTY KEY LAYOUT as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A data input device, comprising:
one and only one row of user-manipulable letter keys, the letter keys being the only means on the device to input letter characters; and
at least one selector element, the selector element being manipulable by a user at least to selectively cause the row of user-manipulable letter keys to instantiate a top row of keys in a QWERTY layout, or a middle row of keys in a QWERTY layout, or a bottom row of keys in a QWERTY layout.

2. The device of claim 1, wherein the selector element includes at least two buttons.

3. The device of claim 1, wherein the selector element includes at least one spring-loaded flip switch.

4. The device of claim 1, wherein the selector element includes at least one jog roller.

5. The device of claim 1, wherein the keys are arranged in an arcuate pattern.

6. The device of claim 1, wherein the selector element can be manipulated to cause the row to instantiate a row of number keys.

7. The device of claim 1, further comprising plural non-alphanumeric special function keys.

8. A data input device, comprising:
plural letter keys arranged in a single row, at least some letter keys representing a user-selected one of at least three letters, such that which letter is represented by a letter key is selected by a user.

9. The device of claim 8, further comprising a selector element manipulable by a user to select a row of letters to be instantiated by at least some of the letter keys.

10. The device of claim 9, wherein the letter keys represent a top row of keys in a QWERTY layout when the selector element is in a first position, a middle row of keys in a QWERTY layout when the selector element is in a second position, and a bottom row of keys in a QWERTY layout when the selector element is in a third position.

11. The device of claim 9, wherein the selector element includes at least two buttons.

12. The device of claim 9, wherein the selector element includes at least one spring-loaded flip switch.

13. The device of claim 9, wherein the selector element includes at least one jog roller.

14. The device of claim 8, wherein the keys are arranged in an arcuate pattern.

15. The device of claim 9, wherein the selector element can be manipulated to cause the row to instantiate a row of number keys.

16. The device of claim 8, further comprising plural non-alphanumeric special function keys.

17. A data entry device, comprising:
plural letter keys, at least some letter keys being correlatable to one of at least three letters; and
means for allowing a user to correlate at least one letter key to one of plural letters.

18. The device of claim 17, comprising one and only one row of letter keys.

19. The device of claim 18, wherein the selector element is manipulable by a user to selectively cause the row of letter keys to instantiate a top row of letters in a QWERTY layout, a middle row of letters in a QWERTY layout, or a bottom row of letters in a QWERTY layout.

20. The device of claim 19, wherein the means for allowing includes at least two buttons.

21. The device of claim 19, wherein the means for allowing includes at least one spring-loaded flip switch.

22. The device of claim 19, wherein the means for allowing includes at least one jog roller.

23. The device of claim 18, wherein the keys are arranged in an arcuate pattern.

24. The device of claim 18, wherein the means for allowing can be manipulated to cause the row to instantiate a row of number keys.

25. The device of claim 17, further comprising plural non-alphanumeric special function keys.

26. A logic device, comprising:
means for receiving a user row selection signal; and
means for correlating a row of user manipulable keys to one of at least three QWERTY-arranged key rows in response to the row selection signal.
